(19) United States
(12) Patent Application Publication
(10) Pub. No.: US 2014/0294366 A1
(43) Pub. Date: Oct. 2, 2014

(54) Capture, Processing, And Assembly Of Immersive Experience

(71) Applicant: Michael-Ryan FLETCHALL, Idaho Falls, ID (US)

(72) Inventor: Michael-Ryan FLETCHALL, Idaho Falls, ID (US)

(21) Appl. No.: 13/854,752

(22) Filed: Apr. 1, 2013

(51) Int. Cl. H04N 13/00; H04N 5/225; G11B 31/00; H04N 13/02

(52) U.S. Cl. CPC H04N 13/0055; H04N 13/0239; H04N 5/2253; G11B 31/006
USPC 386/341; 348/47

(57) ABSTRACT

A headgear for capturing an immersive experience includes two cameras and two microphone pairs, each with a low volume microphone and a high volume microphone. A global positioning system (GPS) tracking device, accelerometer, and gyroscope are also provided. The data recorded from the cameras, microphones, GPS tracking device, accelerometer, and gyroscope are used to record several feeds and assemble said feeds into a single multimedia clip. Multimedia clips can be combined by time and/or region, forming an aggregate clip for a district or city. The component multimedia clips are linked to each other, allowing a user to experience the aggregate multimedia clip at their direction. Scenarios and advertisements can be embedded into the aggregate multimedia clip, allowing the immersive experience to be used for education, policy analysis, entertainment, and other similar tasks. Information from the GPS tracking device, accelerometer, and gyroscope are used to synchronize audio-video feeds and insert scenarios.

### FIELD OF THE INVENTION

The present invention relates generally to an apparatus and method for recording, processing, and assembling an immersive experience through the use of cameras, microphones, and sensors.

### BACKGROUND OF THE INVENTION

Video cameras are used for a variety of low-end and high-end purposes, whether creating a home view or producing a blockbuster film. While camera technology has advanced significantly since its inception, recently providing three-dimensional filming capabilities, the videos filmed are generally stand-alone products, with little integration to other videos and media. Initially, three-dimensional cameras were large and bulky, but improvements in technology have resulted in size reductions. The size of three-dimensional cameras has been reduced to the point where they can be mounted on headgear and similar accessories. Inversely related to the size, as time has progressed the resolution available with three-dimensional cameras has increased. Overall, the three-dimensional cameras offered today offer much smaller sizes and better resolutions than were available when three-dimensional camera systems were first introduced.

While there are many services for viewing videos, whether amateur or professional, these serves merely act as hosts and provide little additional value, perhaps provided a list of recommended videos. While this may be helpful in researching a topic, such as a person's next vacation destination, recommended videos are still completely separate from the source video. The switch between videos is abrupt, and linked videos aren't always relevant; while the city may be the same, one video may cover a street while a linked video may discuss a shop on the opposite side of town.

In addition, videos are non-interactive. While videos are used for a number of professional purposes, such as education videos, there remains room for improvement by introducing an element of user interaction. This interactive element can be used to enhance numerous projects, such as policy analysis, polls, and lab instructions for students.

There exists a need for a product that is able to record, process, sort, and link videos based on geographic location. There also exists a need for a video system that incorporates user interaction.

It is therefore an object of the present invention to provide an immersive capture system capable of recording video, audio, and data. It is a further object of the present invention to provide a method for creating a multimedia clip by combining recorded video and audio. It is a further object of the present invention to sort a large number of multimedia clips into geographic regions and to link together clips in each geographic region. It is a further object of the present invention to provide a number of audio-visual cues in the aggregate multimedia clip to introduce an element of user interaction.

### BRIEF DESCRIPTION OF THE DRAWINGS

FIG. 1 is a perspective view of the headgear of the present invention.

FIG. 2 is a front view of the headgear with part of the chinstrap omitted.

FIG. 3 is a rear view of the headgear with part of the chinstrap omitted.

FIG. 4 is a diagram showing the electrical and electronic connections of the headgear.

FIG. 5 is a flowchart illustrating the general capture process of the present invention.

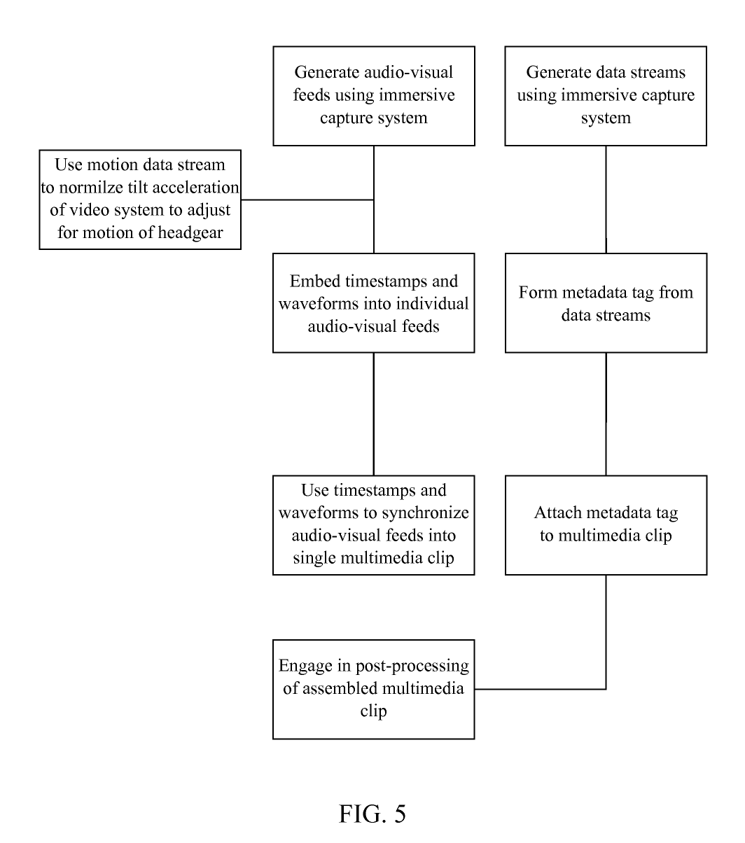

FIG. 6 is a flowchart illustrating the synchronization process of the present invention.

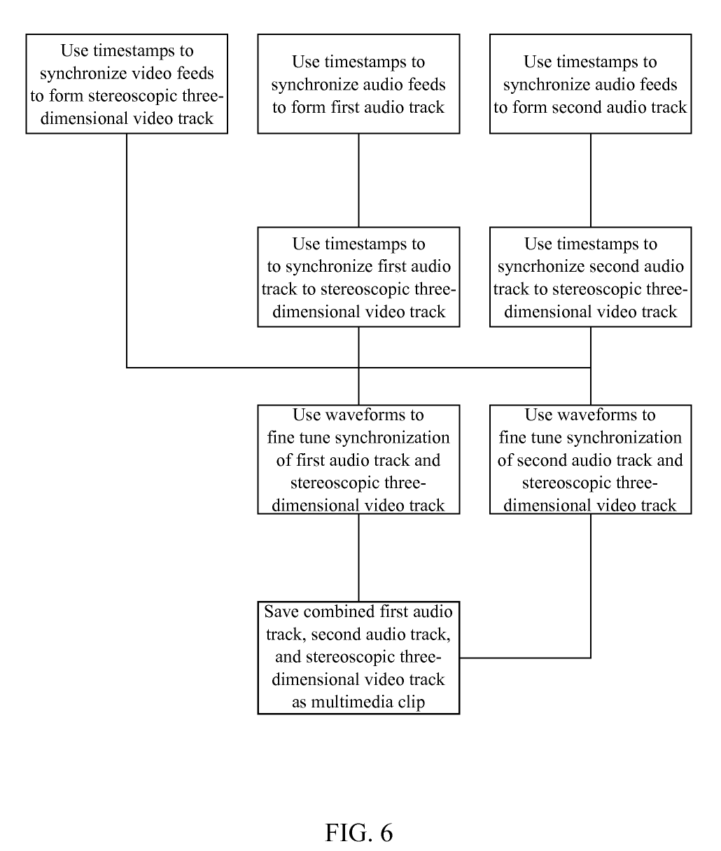

FIG. 7 is a flowchart illustrating the correction process of the present invention.

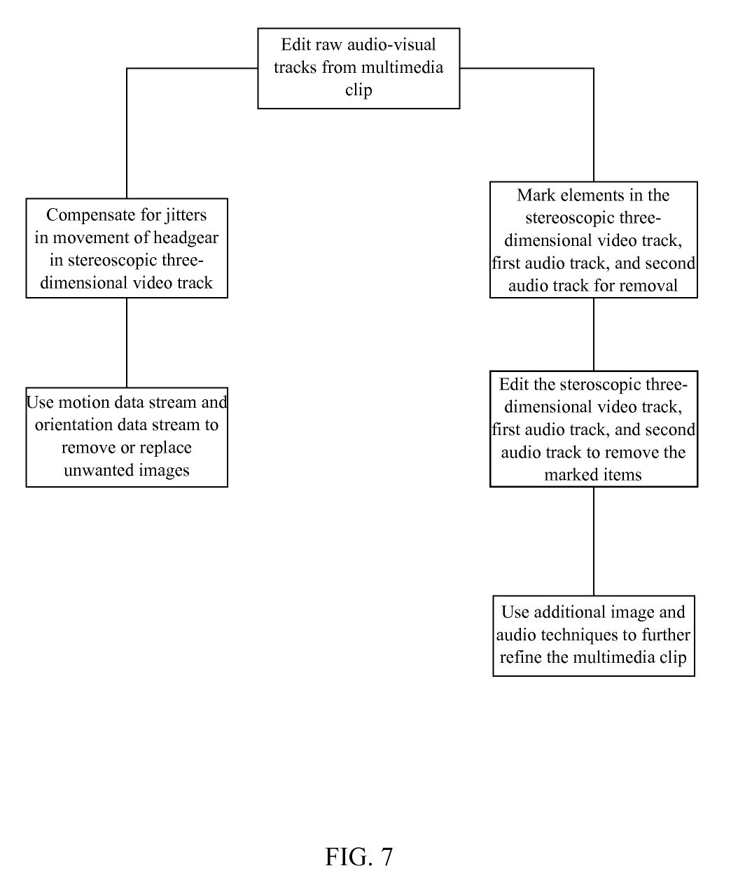

FIG. 8 is a flowchart illustrating the general assembly process of the present invention.

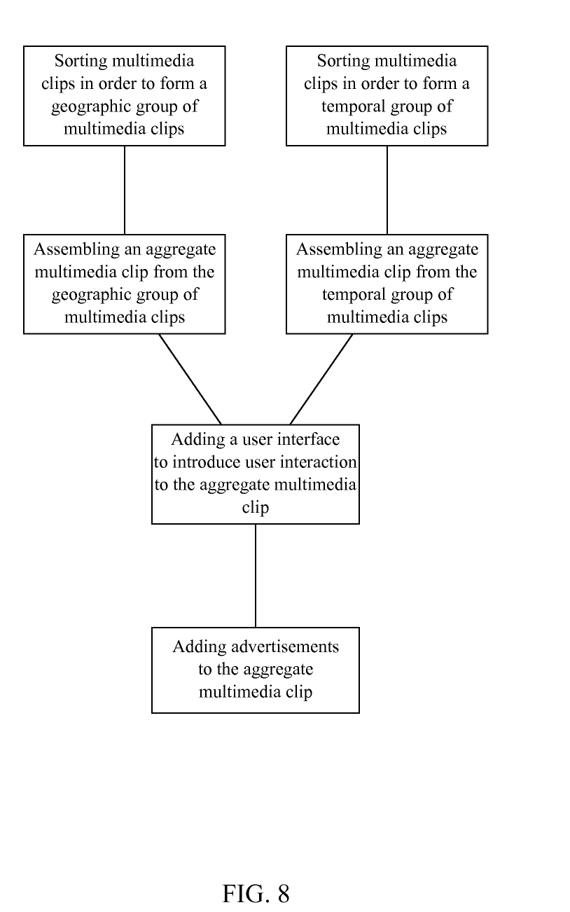

FIG. 9 is a flowchart illustrating the aggregation process of the present invention.

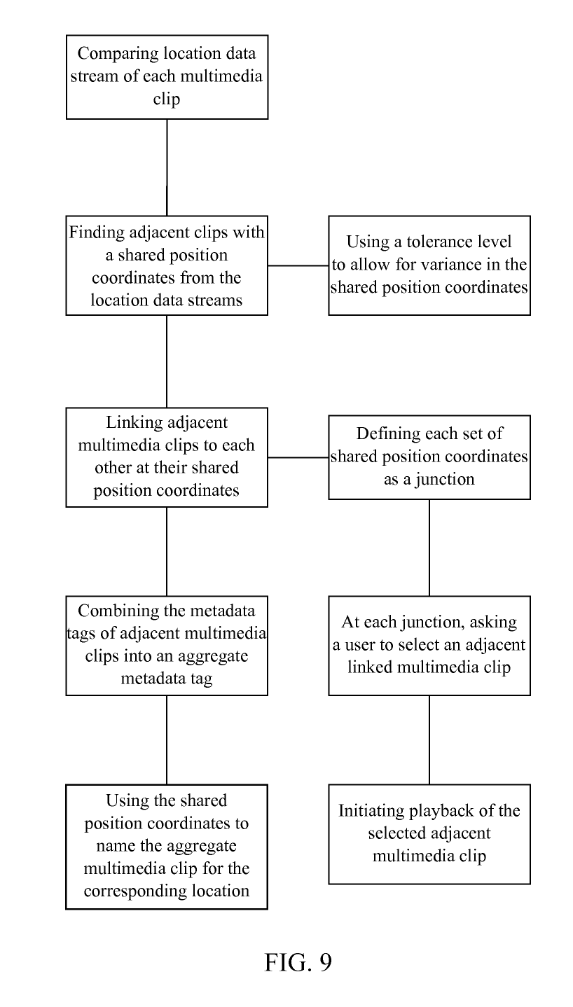

FIG. 10 is a flowchart illustrating the interactive process of the present invention.

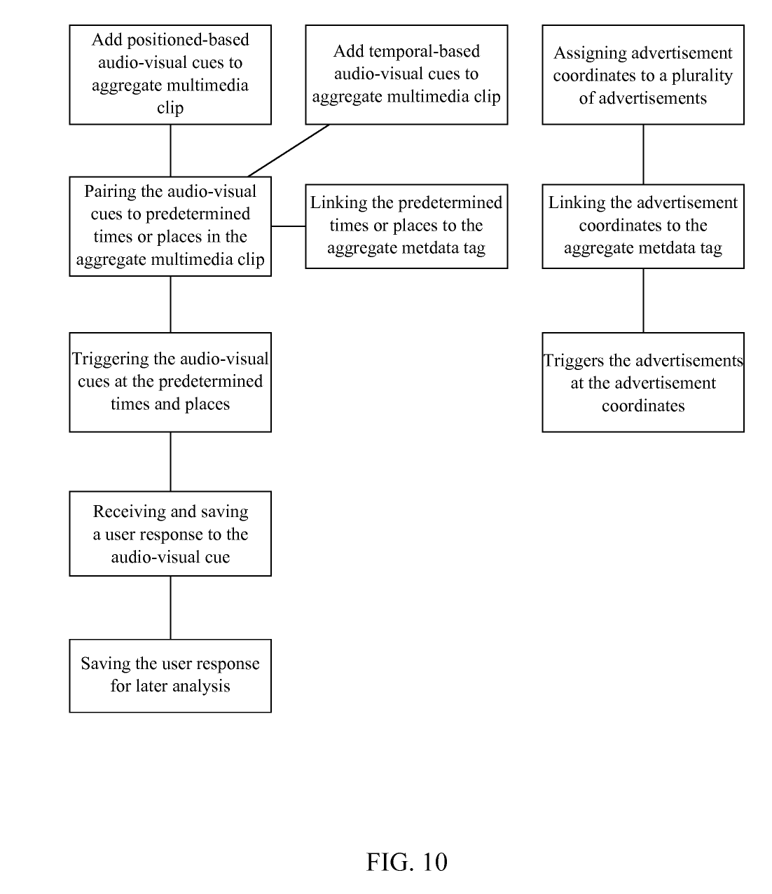

### DETAIL DESCRIPTIONS OF THE INVENTION

All illustrations of the drawings are for the purpose of describing selected versions of the present invention and are not intended to limit the scope of the present invention.

The present invention is an immersive capture system that enables the recording, processing, and assembly of an immersive multimedia experience. The immersive capture system comprises a headgear 1, a video system 2, a binaural audio system 3, a portable power source 4, a global positioning system (GPS) tracking device 4, a chipset 6, an accelerometer 7, a gyroscope 8, and a compass 9. The portable power source 4 provides the energy to run the video system 2, the binaural audio system 3, the portable power source 4, the GPS tracking device 4, and the chipset 6. The video system 2 is mounted to the front of the headset, while the binaural audio system 3 is mounted on each side of the headset. The GPS tracking device 4 and the chipset 6 are housed within the structure of the headgear 1.

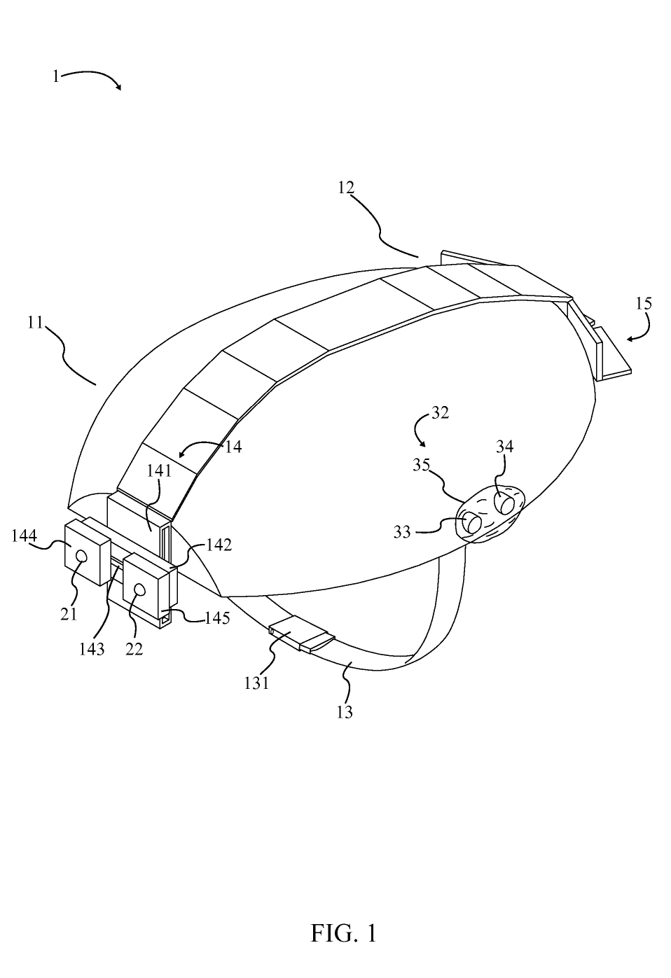

The headgear 1, as illustrated in FIG. 1-FIG. 3, comprises a front section 11, a rear section 12, a camera mount 14, a chinstrap 13, and a rear shelf 15. The front section 11 and rear section 12 form opposite parts of the headgear 1, with the camera mount 14 being adjacent to the front section 11. The chinstrap 13 is connected across the headgear 1, to a left side and a right side. The camera mount 14 itself comprises a vertical track 141, a cart 142, a horizontal track 143, a first housing socket 144, and a second housing socket 145 while the chinstrap 13 comprises a buckle 131. The vertical track 141 is connected to the front section 11 of the headgear 1, securing the camera mount 14 to the headgear 1. The rear shelf 15 is connected to the rear section 12 of the headgear 1, opposite the camera mount 14.

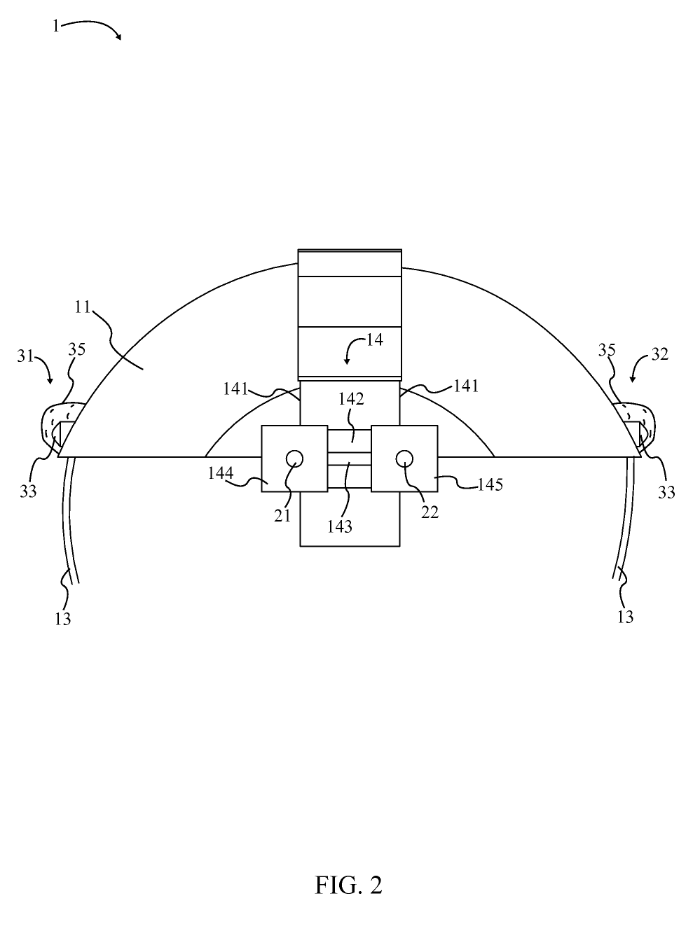

Engaged with the vertical track 141 is the cart 142, which is capable of sliding up and down along the vertical track 141. The interaction of the cart 142 and the vertical track 141 allow the video system 2 to be adjusted in the vertical direction. Centrally connected to the cart 142, on the opposite side of the vertical track 141, is the horizontal track 143. The horizontal track 143 is oriented to be perpendicular to the vertical track 141, and serves as a mounting point for the first housing socket 144 and the second housing socket 145. The first housing socket 144 and the second housing socket 145 are slidably engaged with the horizontal track 143, enabling lateral motion along the horizontal track 143. The buckle 131 of the chinstrap 13 is centrally positioned; by engaging or disengaging the buckle 131 the headgear 1 may be secured to or released from a user's chin. The components of the headgear 1 serve to secure the headgear 1 to a user's chin as well as provide vertical and horizontal motion for a connected video system 2. These arrangements are visible in FIG. 1 and FIG. 2.

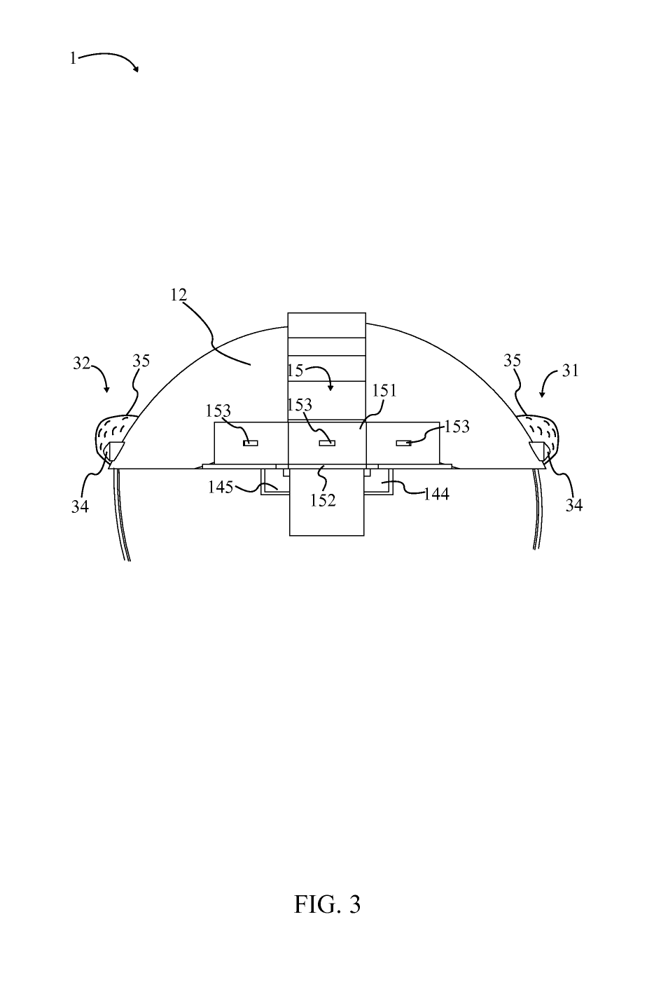

The rear shelf 15 comprises a wall 151, a floor 152, and a plurality of inputs 153. The wall 151 is connected to the rear section 12, securing the rear shelf 15 to the rear section 12. Connected perpendicular to the wall 151 is the floor 152, forming a support for accessory devices which may be connected to the headgear 1. These accessory devices, which can enable a number of functions such as additional audio capabilities, removable storage, and auxiliary batteries, interface with the headgear 1 through the plurality of inputs 153. For example, digital audio recording could be secured and connected to the headgear 1 by means of the rear shelf 15. The plurality of inputs 153 are positioned on the wall 151, providing a proximal connection point for any accessories that are secured to the floor 152. The rear shelf 15 is visible in FIG. 3.

The video system 2 comprises a first camera 21, a second camera 22, a data storage device 23, and a wireless transmitter 24. The first camera 21 and the second camera 22 are secured to the camera mount 14 while the data storage device 23 and the wireless transmitter 24 are housed within the headgear 1. The first camera 21 is placed in the first housing socket 144 while the second camera 22 is placed in the second housing socket 145. The first camera 21 and second camera 22 are provided with two degrees of freedom in the rotational element; that is, they are capable of tilting and pivoting in relation to the first housing socket 144 and the second housing socket 145. The tilt capability allows for looking up and down, while the pivot capability is allows for convergence (e.g. refocusing as an object moves closer). Potentially, a swivel capability can be added, enabling looking left and right. With the swivel function added, the present invention would then have 3 degrees of freedom in the rotational element. In combination with the first vertical track 141 and the second vertical track 141, the first camera 21 and the second camera 22 are provided with two translational degrees of freedom and two rotational degrees of freedom.

The binaural audio system 3 comprises an identical left subsystem 31 and a right subsystem 32. The left subsystem 31 and the right subsystem 32 each comprise a low volume microphone 33, a high volume microphone 34, and a windsock 35. The left system subsystem is positioned on the left side of the headgear 1, which is mirrored by the right subsystem 32 on the right side of the headgear 1. The left subsystem 31 and the right subsystem 32, positioned on opposite sides of the headgear 1, are located at the junction between the front section 11 and the rear section 12 of the headgear 1. The left subsystem 31 is ideally positioned to be directly above the left ear of a person wearing the headgear 1, just as the right subsystem 32 is ideally positioned above a user's right ear. The low volume microphone 33 is specialized to best record proximal sounds, where less sensitivity is needed to cleanly record audio. For sounds that originate further away from the headgear 1, the high volume microphone 34 provides more sensitivity that helps cleanly record distal sounds which might be, at best, faintly audible through the low volume microphone 33. Covering each pair of microphones is the windsock 35, intended to minimize the amount of noise picked up, especially from wind.

To power the present invention, the portable power source 4 is installed in the headgear 1. The portable power source 4 is connected to multiple components of the present invention, supplying power to the video system 2, the binaural audio system 3, the GPS tracking device 4, the chipset 6, the accelerometer 7, the gyroscope 8, the compass 9, and the plurality of inputs 153. To enable communication and data transfer between the systems of the headgear 1, the chipset 6 is included as a central hub. The chipset 6 is electronically coupled to the first camera 21, the second camera 22, the data storage device 23, the wireless transmitter 24, the high volume microphone 34, the low volume microphone 33, the GPS tracking device 4, the accelerometer 7, the gyroscope 8, and the compass 9. The chipset 6 enables the various components of the headgear 1 to communicate with each other, e.g. saving video recorded by the first camera 21 and the second camera 22 to the data storage device 23.

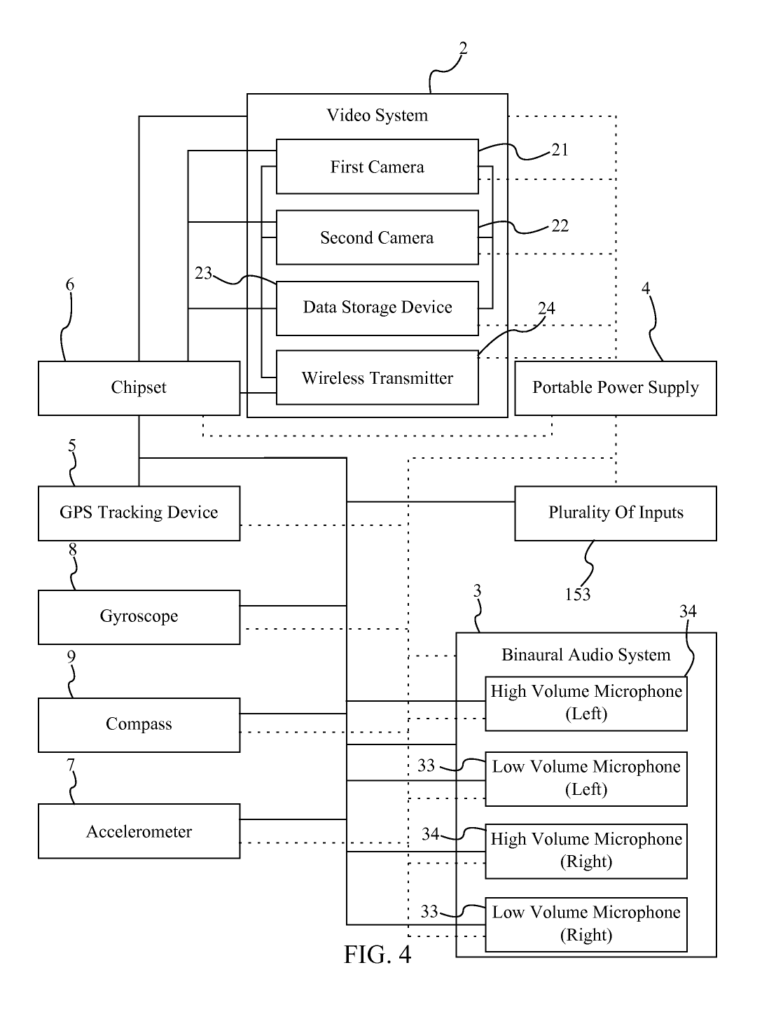

While the cameras and microphones allow the headgear 1 to record video and audio, the data storage device 23, the wireless transmitter 24, GPS tracking device 4, accelerometer 7, gyroscope 8, and compass 9 provide additional capabilities that are especially helpful when processing the recorded video and audio. The GPS tracking device 4 continuously records position coordinates including altitude during filming, allowing the recorded video to be matched to a geographic location. The accelerometer 7 measures the pitch of the headgear 1, allowing rapid changes in tilt to be accommodated for by the first camera 21 and the second camera 22. Similarly, the gyroscope 8 tracks orientation of the headgear 1, enabling camera shake and similar undesired effects to be smoothed out during video processing. The compass 9 tracks the directional heading of the headgear 1, which can be added to the recorded video. The data storage device 23 provides local storage, allowing the headgear 1 to add the recorded media to the data storage device 23. The wireless transmitter 24 allows for remote viewing of the live feeds generated from the video system 2, audio system, and accessory devices like the GPS tracking device 4, accelerometer 7, gyroscope 8, and compass 9. For example, a producer in a studio room could view the real time video and audio being captured by the present invention, along with the positional, motion, orientation, and directional data being recorded by the accessory devices. Potentially, the live-streamed data could be saved to a remote location, providing a producer or other viewer with a local copy separate from that saved to the data storage device 23. These connections between the chipset 6, portable power source 4, and other components of the present invention are shown in FIG. 4. The headgear 1 of the present invention is designed to allow for the capture of an immersive experience, as well as the subsequent processing and assembly of the immersive experience. Creating the immersive experience requires two core processes, with the material for said processes being generated by the headgear 1 of the present invention.

The first process is the capture and processing of the immersive experience. The ability to capture the experience is provided by the headgear 1. The first camera 21 and the second camera 22 are used to generate a first video feed and a second video feed. The binaural audio system 3 generates four separate feeds; a first high volume audio feed from a first high volume microphone 34, a first low volume audio feed from a first low volume microphone 33, a second high volume audio feed from a second high volume microphone 34, and a second low volume audio feed from a second low volume microphone 33. In addition to generating these video and audio feeds, a timestamp is embedded throughout the entirety of each feed; a first video timestamp for the first video feed, a second video timestamp for the second video feed, a first high volume timestamp for the first high volume audio feed, a first low volume timestamp for the first low volume audio feed, a second high volume timestamp for the second high volume audio feed, and a second low volume timestamp for the second low volume audio feed. These generated feeds and timestamps are saved to the local data storage device 23, allowing them to be accessed for later steps in the editing process.

In addition to the audio-visual feeds, data streams are provided by the GPS tracking device 4, the accelerometer 7, and the gyroscope 8. More specifically, the GPS tracking device 4 generates a location data stream, the accelerometer 7 generates a motion data stream, and the gyroscope 8 generates an orientation data stream. A directional facing data stream is also generated by the compass 9. Along with the audio-visual feeds, these data streams are saved to the data storage device 23. The audio-video feeds and the data streams provided the starting material for the immersive experience, which must next be processed and finally assembled into the desired finished product. The motion data stream from the accelerometer 7 can be used to make real time adjustments to the first camera 21 and the second camera 22 during filming; movements such as tilting of the headgear 1 can be accommodated for with corresponding changes to the tilt of the first camera 21 and the second camera 22.

Once the raw data has been recorded by the headgear 1, the processing stage can begin. To do this, the audio-visual feeds first need to be combined into tracks. The first video feed and the second video feed are merged to create a stereoscopic three-dimensional track, the first high volume audio feed and first low volume audio feed are merged to create a first audio track, and the second high volume feed, and second low volume audio feed are merged to create a second audio track. To ensure that the feeds of the combined components are synchronized, each feed is matched to its partner using the embedded timestamp. For example, the first video timestamp and the second video timestamp are referenced when creating the stereoscopic three-dimensional video track. The result is that the first video feed and second video feed are completely synchronized with each other, starting and stopping at the same time to provide a smooth stereoscopic three-dimensional video track. In the same way, the first high volume timestamp and first low volume timestamp are used to synchronize the first high volume audio feed and first low volume audio feed, thus generating the first audio track. Likewise, the second audio track is generated by using the second high volume timestamp and second low volume timestamp to synchronize the second high volume audio feed to the second low volume audio feed.

After synchronizing the generated feeds to create the stereoscopic three-dimensional video track, first audio track, and second audio track, the three tracks are saved together as a multimedia clip, added to the local data storage device 23. The same process that is used to create the tracks is used to create the multimedia clip. By matching the timestamps of the component tracks, the multimedia clip is assembled such that the stereoscopic three-dimensional video track, first audio track, and second audio track are in sync with each other. Since synchronizing by timestamps is not perfect, it is necessary to fine-tune the synchronization. To fine tune the synchronization of the first audio track and the second audio track to the stereoscopic three-dimensional video track, waveforms generated by the video system 2 and audio system are used. As the first camera 21 and second camera 22 generate the first video feed and the second video feed, a first video waveform and second video waveform are also produced. Similarly, a first high volume waveform, first low volume waveform, second high volume waveform, and second low volume waveform are produced along with the first high volume audio feed, first low volume audio feed, second high volume audio feed, and second low volume audio feed, respectively. After synchronizing the timestamps of the audio-video feeds, the waveforms of each feed can be matched to each other to produce an exact match.

To provide various information about the multimedia clip, a metadata tag is inserted into the multimedia clip. The metadata tag is formed from the location data stream, the orientation data stream, and the motion data stream. As a result, information regarding the coordinates, camera orientation, and camera motions is readily available; this is especially important in the processing of the multimedia clip, where such information is used to make adjustments and corrections to imperfections or errors in the multimedia clip.

With the multimedia clip having been fully prepared, processing of the multimedia clip can proceed. Processing of the multimedia clip involves numerous adjustments, corrections, and accommodations to the multimedia clip. By referencing the orientation data stream and the motion data stream (accessed through the metadata tag), the stereoscopic three-dimension video track can be stabilized, eliminating a plurality of jitters that would otherwise detract from the viewing experience. The multimedia clip is reviewed for other unwanted events, which are removed or adjusted through editing. Processing can also be used to add elements to the multimedia clip, or alter existing element for artistic purposes. Processing the multimedia clip may involve a number of steps, such as rotoscoping, color correction, adjusting convergence, focus, fisheye, and zoom, as well as depth mapping.

Once the multimedia clip has been captured and processed, the assembly of the immersive experience can begin. Creating the immersive experience requires a plurality of immersive capture systems, such as the headgear 1, generating a plurality of multimedia clips. The first step in assembling the immersive experience is grouping the plurality of multimedia clips into geographic group of multimedia clips, wherein each geographic group of multimedia clip is formed by a minimum of two multimedia clips. The creation of the geographic group of multimedia clips is done by comparing the metadata tag of each of the plurality of multimedia clips. By looking at coordinates in the location data stream from each metadata tag, multimedia clips which are from proximal locations (as indicated by their respective location data streams) can be combined in the geographic group of multimedia clips. Alternatively, instead of having the present invention automatically link together multimedia clips in a geographic region, a producer can create a playlist of multimedia clips. For example, in order to create a fine dining tour of Paris, a producer might create a playlist of video clips that explore a number of restaurants in Paris, even if the sequential videos are not immediately geographically adjacent. Creating a playlist is not limited to a producer; a user or anyone with access to a plurality of multimedia clips can selectively arrange, remove, and otherwise edit them to create a playlist.

Potentially, the geographic group of multimedia clips can be grouped by time as well as or instead of location. For example, by accessing the timestamps from the metadata tags, time variants of geographic groups of multimedia clips can be formed. Multimedia clips generated in one year, e.g. 2000, would be arranged into one geographic group of multimedia clips for a region. Multimedia clips for that same region, but with different capture dates such as 2010, are then grouped into a separate geographic group of multimedia clips for the region. Alternatively, a group of multimedia clips can be combined to form highlights of a 2010 multimedia experience, for example. By providing multimedia clips that are sorted not only by location, but also time, the present invention allows a user to experience different eras as well as different locations.

To improve the immersive experience, an accessory data stream can be incorporated as part of the metadata tag. This accessory data stream serves as a connection point for accessory devices. These accessory devices are added in order to provide accessory feedback to the multimedia clip. While the audio-video feeds address the senses of sight and sound, the accessory devices can target the other senses. For example, by including a vibrating device the sensation of touch can be incorporated into the immersive experience. As an example, a vibrating chair can be fed the information from the accessory data stream, shaking to add a tactile element to the accessory data stream. More specifically, if an earthquake occurs as part of the immersive experience, the vibrating chair will shake as the earthquake unfolds. Resultantly, a user will not only see and hear the effects of the earthquake, but feel them as well.

Subsequently, the individual clips from the geographic group of multimedia clips are linked to each other. This is done by comparing the location data stream of each of the component multimedia clips. When a reference multimedia clip and an adjacent multimedia clip have location data streams that show shared position coordinates, the reference multimedia clip and the adjacent multimedia clip can be linked together at or near those shared position coordinates. This linking of the reference multimedia clip and the adjacent multimedia clip effectively acts as an aggregate multimedia clip. For example, if the reference multimedia clip ends at an intersection and the adjacent multimedia clip begins at that same intersection, the two multimedia clips are linked. Since two adjacent multimedia clips will usually not have an exact match in shared position coordinates, a tolerance level is set to determine how close to an exact match the shared position coordinates need to be in order to link the two multimedia clips. This creates the aggregate multimedia clip, which switches from playing the reference multimedia clip to the adjacent multimedia clip at the junction, essentially acting as a single larger multimedia clip. These adjacent multimedia clips act as linked multimedia clips with regards to the reference multimedia clip. Ideally, the transition between the reference multimedia clip and adjacent multimedia clip is seamless, occurring exactly at the shared position coordinates. Potentially, a reference multimedia clip can be linked to multiple adjacent multimedia clips. For example, if the reference multimedia clip ends at a four-way intersection there are three potential adjacent multimedia clips to link to. These adjacent multimedia clips correspond to continuing straight, turning left, or turning right at the intersection. Provided enough initial multimedia clips, large areas such as districts and cities can be represented through the geographical group of multimedia clips. The plurality of multimedia clips from the geographical group is saved together to a central storage location as an aggregate multimedia clip Likewise, the metadata tags of the plurality of multimedia clips are combined to provide an aggregate metadata tag for the aggregate multimedia clip. This aggregate multimedia clip is named to indicate the captured geographical region. By looking through the metadata tags and location data streams of the component multimedia clips, the position coordinates can be converted to the appropriate geographic location, which is then used as the name for the aggregate multimedia clip. For example, given the coordinates of 48.87, 2.34 indicates that the aggregate metadata clip should be named Paris.

Beyond simply linking adjacent multimedia clips together to form the aggregate metadata clip, the present invention provides an element of user interaction. Defining a junction of shared position coordinates where a reference multimedia clip is linked to an adjacent multimedia clip, the present invention allows a user to make a choice at each junction. When a user watching the aggregate multimedia clips reaches a junction, they are prompted to choose a linked multimedia clip to continue to. The user interaction is enabled by an integrated user interface, which can be implemented in various designs depending on the playback machine of choice. Returning to the earlier example, at a four way intersection a user may choose between continuing straight, turning left, or turning right, with each choice linking the user to the appropriate linked multimedia clip. Provided a large enough database, this allows a user to take an immersive tour of a city, even entering individual stores or buildings when the relevant multimedia clips are available.

Expanding upon the user interaction, scenarios can be presented throughout the aggregate multimedia clip by utilizing a plurality of audio-visual cues. There are two variations; position-based audio-visual cues and temporal-based audio-visual cues. The position-based cues are tied to predetermined physical positions, a set of coordinates from the location data stream of the aggregate metadata tag. Parallel to the position-based cues, the temporal-based cues are tied to a specific timestamp from the aggregate metadata tag. This enables a specific position-based cue or a specific temporal-based cue to be triggered at a specific location or time in the aggregate multimedia clip. For example, a specific positioned-based cue can be triggered at a crosswalk while a specific temporal-based cue can be triggered two minutes into the aggregate multimedia clip. Once these audio-visual cues are triggered, a user is prompted for a response, which is saved to the central data storage. This allows a user's response to various scenarios and challenges to be presented in an immersive environment and saved for later analysis.

Further utilization of the aggregate metadata tag includes inserting a plurality of location-based advertisements throughout the aggregate multimedia clip. This is accomplished by providing a plurality of different advertisement coordinates, themselves selected from the coordinates provided in the location data stream. Specific location-based advertisements are then linked to specific advertisement coordinates. These location-based advertisements are triggered when the coordinates from the location data stream match the specific advertisement coordinates. This allows relevant advertising to be inserted into the aggregate multimedia clip. For example, a user may be previewing a trip to Paris by viewing an aggregate multimedia clip for the Paris region. During the aggregate multimedia clip, a local bakery is passed, triggering an advertisement for that specific bakery. This could influence the user to go to said bakery during a physical visit to Paris. This is just one example of many potential advertisements.

The immersive experience provided by the present invention can be used in a number of applications. For example, the aggregate multimedia clip can be used to provide an immersive experience from another person's point of view; a user could experience great cities, famous landscapes, and different cultures through the aggregate multimedia clip. Alternatively, in combination with the audio-visual cues, the aggregate multimedia clip can be used for more interactive tasks such as policy analysis or education. For example, by creating a specific plurality of audio-visual cues, a police department can see if their officer's responses are in line with official police policy. Or, in the education sector, the audio-visual cues can guide a student through the proper procedure in an experiment, testing their ability to follow guidelines without using up valuable physical lab space and materials. The educational application of the present invention is especially relevant to blended learning, where an immersive experience can be used to replicate real-time, hands-on, or practical experience, which are often requirements for completing a class. Traditionally, these requirements require an investment in time and money, either on the part of the instructor or the students (e.g. travelling to a lab for hands on experience). The immersive experience provided by the present invention is capable of imitating these practical experiences, thus improving the blended learning approach. These are just a few examples of applications that utilize the present invention; additional ways of integrating the aggregate multimedia clip and audio-visual cues can be implemented in sectors such as entertainment, healthcare, education, and business.

The immersive experience is designed to provide a stereoscopic three-dimensional experience; however, users may choose to use traditional two-dimensional displays as a more cost effective way of experiencing the aggregate multimedia clip. In the ideal situation, a user will be able to experience the aggregate multimedia clip through a closed environment, such as three-dimensional goggles with integrated headphones.

Although the invention has been explained in relation to its preferred embodiment, it is to be understood that many other possible modifications and variations can be made without departing from the spirit and scope of the invention as hereinafter claimed.

What is claimed is:

1. An immersive capture system comprises:
a headgear;
a video system;
a binaural audio system;
a portable power source;
a global positioning system (GPS) tracking device;
a chipset;
the headgear comprises a front section, a rear section, and a camera mount;
the video system comprises a first camera, a second camera, a data storage device, and a wireless transmitter;
the binaural audio system comprises a left subsystem and a right subsystem;
the left subsystem and the right subsystem each comprise a low volume microphone, a high volume microphone, and a windsock, wherein the low volume microphone records low decibel sounds and the high volume microphone records high decibel sounds;
the first camera and the second camera being secured to the camera mount;
the video system, the binaural audio system, and the GPS tracking device being electrically connected to the portable power source;
the video system, the binaural audio system, and the GPS tracking device being electronically coupled to the chipset; and
the GPS tracking device being housed within the headgear.

2. The immersive capture system as claimed in claim 1 comprises:
the headgear further comprises a chin strap;
the chin strap comprises a buckle, wherein the chin strap can be separated by disengaging the buckle;
the camera mount comprises a vertical track, a cart, a horizontal track, a first housing socket, and a second housing socket;
the chin strap being connected to the headgear between the front section and the rear section;
the camera mount being positioned adjacent to the front section;
the vertical track being connected to the headgear;
the cart being slidably engaged with the vertical track;
the horizontal track being positioned adjacent to the cart opposite the vertical track;
the horizontal track being centrally connected to the cart; and
the first housing socket and the second housing socket being slidably engaged with the horizontal track.

3. The immersive capture system as claimed in claim 2 comprises:
the first housing socket and the second housing socket being positioned adjacent to each other;
the first camera being diathrotically engaged with the first housing socket, wherein the first camera is tiltable and pivotable; and
the second camera being diathrotically engaged with the second housing socket, wherein the second camera is tiltable and pivotable.

4. The immersive capture system as claimed in claim 1 comprises:
the data storage device being housed in the camera mount;
the wireless transmitter being housed in the camera mount;
the first camera and the second camera being electronically coupled to the data storage device; and
the first camera and the second camera being electronically coupled to the wireless transmitter.

5. The immersive capture system as claimed in claim 1 comprises:
the headgear further comprises a rear shelf;
the rear shelf comprises a wall, a floor, and a plurality of inputs;
the rear shelf being connected to the rear section;
the floor being connected perpendicular to the wall;
the plurality of inputs being positioned on the wall;
the plurality of inputs being electrically connected to the portable power source; and
the plurality of inputs being electronically coupled to the chipset.

6. The immersive capture system as claimed in claim 1 comprises:
the first camera, the second camera, the wireless transmitter, the data storage device, the low volume microphone, and the high volume microphone being electronically connected to the chipset; and
the first camera, the second camera, the wireless transmitter, the data storage device, the lower volume microphone, the high volume microphone, and the chipset being electrically connected to the portable power source.

7. The immersive capture system as claimed in claim 1 comprises:
the left subsystem being positioned adjacent to the front section and the rear section;
the right subsystem being positioned adjacent to the front section and the rear section;
the left subsystem and the right subsystem being positioned opposite each other across the headgear;
the low volume microphone and the high volume microphone being connected to the headgear; and
the low volume microphone and the high volume microphone being enveloped by the windsock.

8. The immersive capture system as claimed in claim 1 comprises:
an accelerometer;
a gyroscope;
a compass;
the accelerometer, the gyroscope, and the compass being housed within the headgear;
the accelerometer, the gyroscope, and the compass being electrically connected to the portable power source; and
the accelerometer, the gyroscope, and the compass being electronically connected to the chipset.

9. A method of capturing and processing an immersive experience comprises the steps of:
providing an immersive capture system, wherein the immersive capture system comprises a first camera, a second camera, a data storage device, a wireless transmitter, a left-side high volume microphone, a left-side low volume microphone, a right-side high volume microphone, a right-side low volume microphone, an accelerometer, a gyroscope, and a global positioning system (GPS) tracking device;
generating a first video feed, a second video feed, a first high volume audio feed, a first low volume audio feed, a second high volume audio feed, and a second low audio volume audio feed with the immersive capture system;
recording a first video timestamp, a second video timestamp, a first high volume timestamp, a first low volume timestamp, a second high volume timestamp, and a second low volume timestamp with the immersive capture system;
recording a first video waveform, a second video waveform, a first high volume waveform, a first low volume waveform, a second high volume waveform, and a second low volume waveform with the immersive capture system;
activating the GPS tracking device in order to generate a location data stream;
activating the accelerometer in order to generate a motion data stream;
activating the gyroscope in order to generate an orientation data stream;
adding the first video feed, the second video feed, the first high volume audio feed, the first low volume audio feed, the second high volume audio feed, the second low volume audio feed, the location data stream, the orientation data stream, and the motion data stream to the data storage device;
combining and synchronizing the first video feed and the second video feed in order to create a stereoscopic three-dimensional video track;
merging the first high volume audio feed and the first low volume audio feed to create a first audio track;
merging the second high volume audio feed and the second low volume audio feed to create a second audio track;
synchronizing the first audio track and the second audio track with the stereoscopic three-dimensional video track;
creating a multimedia clip by combining the stereoscopic three-dimensional video track, the first audio track, and the second audio track;
inserting a metadata tag into the multimedia clip; and
engaging in video post-processing by editing the video clip.

10. The method of capturing and processing an immersive experience as claimed in claim 9 comprises the steps of:
activating a recording function of the first camera in order to generate a first video feed, wherein the first video timestamp and the first video waveform are embedded throughout the first video feed;
activating the recording function of the second camera in order to generate a second video feed, wherein the second video timestamp and the second video waveform are embedded throughout the second video feed;
activating the recording function of the left-side high volume microphone in order to generate a first high volume audio feed, wherein the first high volume time stamp and the first high volume waveform are embedded throughout the first high volume audio feed;
activating the recording function of the left-side low volume microphone in order to generate a first low volume audio feed, wherein the first low volume time stamp and the first low volume waveform are embedded throughout the first low volume audio feed;
activating the recording function of the right-side high volume microphone in order to generate a second high volume audio feed, wherein the second high volume time stamp and the second high volume waveform are embedded throughout the second high volume audio feed; and
activating the recording function of the right-side low volume microphone in order to generate a second low volume audio feed, wherein the second low volume time stamp and the second low volume waveform are embedded throughout the second low volume audio feed.

11. The method of capturing and processing an immersive experience as claimed in claim 9 comprises the step of:
controlling tilting of the first camera and the second camera during the recording process by normalizing a tilt acceleration for the first camera and the second camera to the motion data stream.

12. The method of capturing and processing an immersive experience as claimed in claim 9 comprises the steps of:
retrieving the first video feed, the second video feed, the first high volume audio feed, the first low volume audio feed, the second high volume audio feed, and the second low volume audio feed from the data storage device;
synchronizing the first video feed and the second video feed by matching the first video timestamp to the second video timestamp;
synchronizing the first audio track to the stereoscopic three-dimensional video track by matching the first high volume timestamp and the first low volume timestamp to the first video timestamp and the second video timestamp;
further synchronizing the first audio track to the stereoscopic three-dimensional video track by matching the first high volume waveform and the first low volume waveform to the first video wave form and the second video waveform;
synchronizing the second audio track to the stereoscopic three-dimensional video track by matching the second high volume timestamp and the second low volume timestamp to the first video timestamp and the second video timestamp;
further synchronizing the second audio track to the stereoscopic three-dimensional video track by matching the second high volume waveform and the second low volume waveform to the first video wave form and the second video waveform; and
adding the first audio track, second audio track, and stereoscopic three-dimensional video track to the data storage device as the multimedia clip.

13. The method of capturing and processing an immersive experience as claimed in claim 9 comprises the steps of:
forming the metadata tag by combining the location data stream, the orientation data stream, the motion data stream, and an accessory data stream;
connecting an accessory device to the accessory data stream in order to add an accessory feedback to the multimedia clip; and
adding the metadata tag to the data storage device as part of the multimedia clip.

14. The method of capturing and processing an immersive experience as claimed in claim 9 comprises the steps of:
using the orientation data stream and the motion data stream to compensate for a plurality of jitters in the stereoscopic three-dimensional video track;
viewing the stereoscopic three-dimensional video track, first audio track, and second audio track in order to identify a plurality of unwanted events; and
adjusting the multimedia clip by removing the plurality of unwanted events from the stereoscopic three-dimensional video track, first audio track, and second audio track.

15. A method for assembling an immersive experience comprises the steps of:
providing a plurality of immersive capture systems and a plurality of multimedia clips, wherein the plurality of multimedia clips are generated by the plurality of immersive capture systems and saved to a central storage location;
providing a metadata tag for each of the plurality of multimedia clips;
assembling at least two of the plurality of multimedia clips into a geographic group of multimedia clips;
creating a regional compilation by merging the geographic group of multimedia clips into an aggregate multimedia clip;
prompting for a user input at a plurality of locations through an audio-visual interface; and
incorporating a plurality of location-based advertisements into the aggregate multimedia clip at plurality of different advertisement coordinates along the aggregate metadata tag.

16. The method for assembling an immersive experience as claimed in claim 15 comprises the steps of:
comparing a location data stream from the metadata tag of each of the plurality of multimedia clips to sort proximal multimedia clips into a geographic group of multimedia clips;
setting a variance tolerance in a shared position coordinates, wherein the variance tolerance is used to define a maximum distance for the shared position coordinates when identifying a reference multimedia clip and an adjacent multimedia clip;
linking the reference multimedia clip to the adjacent multimedia clip by matching the metadata tag of the reference multimedia clip to the metadata tag of the adjacent multimedia clip to form the geographic group of multimedia clips, wherein the reference multimedia clip is linked to the adjacent multimedia clip at a shared position coordinates;
creating a seamless transition between the reference multimedia clip and the adjacent multimedia clip by matching the location data stream, an orientation data stream, and a motion data stream from the reference multimedia clip to the adjacent multimedia clip; and
adding the metadata tag of the reference multimedia clip and the adjacent multimedia clip to the aggregate metadata tag.

17. The method for assembling an immersive experience as claimed in claim 16 comprises the steps of:
reading at least one shared position coordinate to determine the location of the regional compilation;
converting the shared positioned coordinates into a geographical location in order to name the aggregate multimedia clip with the geographical location; and
adding the aggregate multimedia clip to the central storage location.

18. The method for assembling an immersive experience as claimed in claim 15 comprises the steps of:
forming a junction between each of the plurality of multimedia clips in the geographic group of media clips;
prompting the user input to select a linked multimedia clip at the junction; and
displaying the linked multimedia clip.

19. The method for assembling an immersive experience as claimed in claim 15 comprises the steps of:
adding a plurality of position-based audio-visual cues to the aggregate multimedia clip;
adding a plurality of temporal-based audio-visual cues to the aggregate multimedia clip;
triggering a specific position-based audio-visual cue at a predetermined physical position in the aggregate multimedia clip, wherein the predetermined physical position is linked to the aggregate metadata tag;
triggering a specific temporal-based audio-visual cue at a predetermined temporal position in the aggregate multimedia clip, wherein the predetermined temporal position is linked to the aggregated metadata tag;
prompting for a user response to the specific position-based audio-visual cue or the specific temporal-based audio-visual cue; and
adding the user response to the central storage location.

20. The method of assembling an immersive experience as claimed in claim 15 comprises the steps of:
assigning a specific advertisement coordinates to each of the plurality of location-based advertisements; and
triggering a specific location-based advertisement at the specific advertisement coordinates.
